(19) United States
(12) Patent Application Publication
(10) Pub. No.: US 2019/0386822 A1
(43) Pub. Date: Dec. 19, 2019

(54) Personalizing an Integrated Circuit that is Produced with Embedded Root of Trust Secret

(71) Applicant: ALTAIR SEMICONDUCTOR LTD., Hod Hasharon (IL)

(72) Inventors: Yehuda Ben-Simon, Ramat Hasharon (IL); Omer Botvinik, Herzliya (IL); Avishay Sharaga, Beit Nehemya (IL)

(21) Appl. No.: 16/432,956

(22) Filed: Jun. 6, 2019

Related U.S. Application Data
(60) Provisional application No. 62/686,015, filed on Jun. 17, 2018.

(51) Int. Cl. H04L 9/08; G06F 8/61; G06K 19/073

(52) U.S. Cl. CPC H04L 9/088; G06K 19/07309; G06F 8/61

(57) ABSTRACT

An Integrated Circuit (IC) includes a nonvolatile storage element and a processor. The nonvolatile storage element is pre-programmed with a Root of Trust (RoT) secret. The processor is configured to receive via an unsecured link a data image that is securely protected based on the RoT secret, the data image containing at least an application program for generating user personal data. The processor is further configured to install the application program in response to verifying, using the RoT secret, that the received data image is trusted, to run the application program to generate the user personal data, securely within the IC, and to report the user personal data using a secured scheme.

### CROSS-REFERENCE TO RELATED APPLICATIONS

This application claims the benefit of U.S. Provisional Patent Application 62/686,015, filed Jun. 17, 2018, whose disclosure is incorporated herein by reference.

### TECHNICAL FIELD

Embodiments described herein relate generally to integrated circuits, and particularly to methods and systems for personalizing an integrated circuit that is produced with an embedded root of trust secret.

### BACKGROUND

Integrated circuits in various applications are provisioned with personal information before being deployed in the field. Such applications include, for example, integrated circuits used in credit cards, SIM cards and other types of smart cards.

### SUMMARY

An embodiment that is described herein provides an Integrated Circuit (IC) that includes a nonvolatile storage element and a processor. The nonvolatile storage element is pre-programmed with a Root of Trust (RoT) secret. The processor is configured to receive via an unsecured link a data image that is securely protected based on the RoT secret, the data image containing at least an application program for generating user personal data. The processor is further configured to install the application program in response to verifying, using the RoT secret, that the received data image is trusted, to run the application program to generate the user personal data, securely within the IC, and to report the user personal data using a secured scheme.

In some embodiments, the IC with the pre-programmed RoT secret is applicable in multiple different host devices selected from a list including: a smart card, a credit card, and a Subscriber Identity Module (SIM) card. In other embodiments, the application program includes a vendor specific program that generates for the IC personal data suitable for a specific vendor, or a generic program that generates for the IC personal data suitable for multiple different vendors. In yet other embodiments, the processor is configured to receive another data image including user specific information provided by a vendor for which the IC is being personalized.

In an embodiment, the processor is coupled to a nonvolatile memory (NVM) device, and the processor is configured to store in the NVM device one or more of (i) the user personal data that was generated using the application program and (ii) other personal data provided in the data image or in another data image. In another embodiment, the processor is configured to protect the user personal data to be reported using one or more cryptographic methods and one or more respective cryptographic keys provided within the data image, within the RoT secret, or agreed, using a key agreement scheme, with a processor to which the user personal data is reported. In yet another embodiment, the received data image includes an image signature generated using a signature-generating key that matches a signature-verification key in the RoT secret, and the processor is configured to verify that the received data image is trusted by verifying the image signature using the signature-verification key of the RoT secret.

In some embodiments, the processor is configured to report the user personal data for verifying that the IC has been uniquely personalized with the user personal data.

There is additionally provided, in accordance with an embodiment that is described herein, a method, including, in an Integrated Circuit (IC) including a nonvolatile storage element that is pre-programmed with a Root of Trust (RoT) secret, receiving via an unsecured link a data image that is securely protected based on the RoT secret, the data image contains at least an application program for generating user personal data. The application program is installed in response to verifying, using the RoT secret, that the received data image is trusted. The application program is run to generate the user personal data, securely within the IC. The user personal data is reported using a secured scheme.

These and other embodiments will be more fully understood from the following detailed description of the embodiments thereof, taken together with the drawings in which:

### BRIEF DESCRIPTION OF THE DRAWINGS

FIG. 1 is a block diagram that schematically illustrates a module comprising an Integrated Circuit (IC) produced with embedded Root of Trust (RoT) secret, and a process carried out for personalizing the IC, in accordance with an embodiment that is described herein; and

FIG. 2 is a flow chart that schematically illustrates a method for personalization of an IC produced with an embedded RoT secret, in accordance with an embodiment that is described herein.

### DETAILED DESCRIPTION OF EMBODIMENTS

### Overview

Various applications require provisioning an IC with unique personal information before being used in the field. Depending on the underlying application, the personal information may be used, for example, for verifying the identification of the IC, validating that the IC resides in an authorized device and granting communication with the IC, to name a few. The process of provisioning an IC with personal information is also referred to as a “personalization process.” An IC that is provisioned with personal data is also referred to as a “personalized IC.”

Example personalized ICs include credit cards that are personalized with the owner data, Subscriber identity Module (SIM) cards that are personalized with card specific data that is later used by the cellular network for linking the SIM card to a user account, and ICs used in any other type of smart cards and other suitable applications.

Embodiments that are described herein provide improved systems and methods for performing a trusted personalization process. In general, to be considered trusted, a personalization process should be resilient to various attacks that may be carried out by unauthorized entities. A major requirement in trusted personalization is to ensure that provisioned personal information is protected from being stolen, e.g., for producing clone or duplicate ICs. In addition, the IC is required to be protected against attacks that attempt to personalize the IC with bogus information.

In principle, personalization schemes that provide significant physical and logical security can be performed within a certified and trusted production site, which is protected against a wide range of possible attacks. In trusted production sites, secret information is typically created by dedicated local servers, and is provisioned into the ICs. A report of the personalized ICs is sent securely to the card owner for verification. Performing IC personalization in trusted production sites is, however, complex and expensive, and may be unsuitable for personalizing low cost devices such as Internet of Things (IoT) devices, e.g., operating in a Low-Power Wide-Area (LPWA) network.

In the disclosed techniques, ICs to be personalized are pre-produced with an embedded Root of Trust (RoT) secret. The RoT secret is used, e.g., in a later stage of the personalization scheme, for loading into the IC a data image that contains an application program for generating personal information internally. Since the trusted domain is the IC itself, the personalization process may be carried out in a non-trusted site.

Consider an embodiment, in which an IC comprises a nonvolatile storage element that was pre-programmed at production with a Root of Trust (RoT) secret. In an embodiment, pre-programming the RoT secret is carried out in a trusted production site. The IC pre-programmed with the RoT secret is applicable in multiple different devices. The IC further comprises a processor, configured to receive via an unsecured link a data image that is securely protected based on the RoT secret. The data image, which is typically generated by an IC vendor of the IC, contains at least an application program for generating user personal data. In some embodiments, the application program designed to generate only part of the personal information required by the IC, whereas other personal data such as identity information may be provided within the image. The processor installs the application program in response to verifying, using the RoT secret, that the received data image is trusted, and runs the application program to generate, within the IC, secured user personal data. Following the personalization, the processor reports information related to the personalization to the IC vendor, using a secured scheme.

In the context of the present application and in the claims, the term “IC vendor” refers herein to any suitable entity that generates protected data images for loading to ICs being personalized. Such entity may be the actual IC vendor or another entity such as a SIM vendor, a credit card vendor or any vendor of a trusted application that is being personalized to the IC.

The data image may comprise a vendor specific part and a user specific part, possibly residing in separate data images. The vendor specific part contains information that is common to the ICs used by that vendor. Vendor specific information may comprise an Operating System (OS), one or more application programs, a common configuration that is shared among all users, and the like. The user specific part may comprise IDs of the IC and/or of the user, credentials for accessing a mobile network, and the like. The user specific information, and in some cases also the vendor specific information, are considered to comprise sensitive information. In some embodiments, the IC internally generates at least some of personal information of the user specific part. This may provide protection against an unauthorized attempt to load a given image that contains this personalization information into multiple ICs.

In some embodiments, the received data image is provided by a given IC vendor and the application program in the data image comprises a vendor specific application program that generates personal data for the IC, as required by the given IC vendor. Alternatively or additionally, an application program provided in the data image comprises a generic application program that generates personal data for ICs of multiple different vendors. In some embodiments, the processor receives another data image comprising user specific information provided by the IC vendor.

The processor is configured to securely store, in a nonvolatile memory (NVM) device one or more of (i) the user personal data that was generated using the application program and (ii) other personal data provided in the data image (or in another data image). The NVM may reside within the IC or externally to the IC, e.g., in a module in which the IC is comprised.

In an embodiment, the data image is protected using an image signature generated using a signature-generating key that matches a signature-verification key in the RoT secret. In this embodiment, the processor verifies that the received data image is trusted by verify the image signature using the signature-verification key of the RoT secret. In some embodiments, the processor reports the user personal data of the IC, e.g., to the IC vendor, by applying to the reported information one or more cryptographic methods using cryptographic keys that match respective cryptographic keys known to the IC vendor. The cryptographic keys may be provided within the data image, within the RoT secret or using any other suitable key agreement scheme.

In the disclosed techniques, the IC itself serves as a trusted domain. This enables performing trusted personalization in a non-trusted site, which is much more simple, cost effective, and scalable compared to conventional personalization in trusted production sites. The RoT secret embedded in the IC at production is suitable for various applications, and therefore the disclosed personalization process does not require pre-production matching between specific IC hardware and vendor image.

### System Description

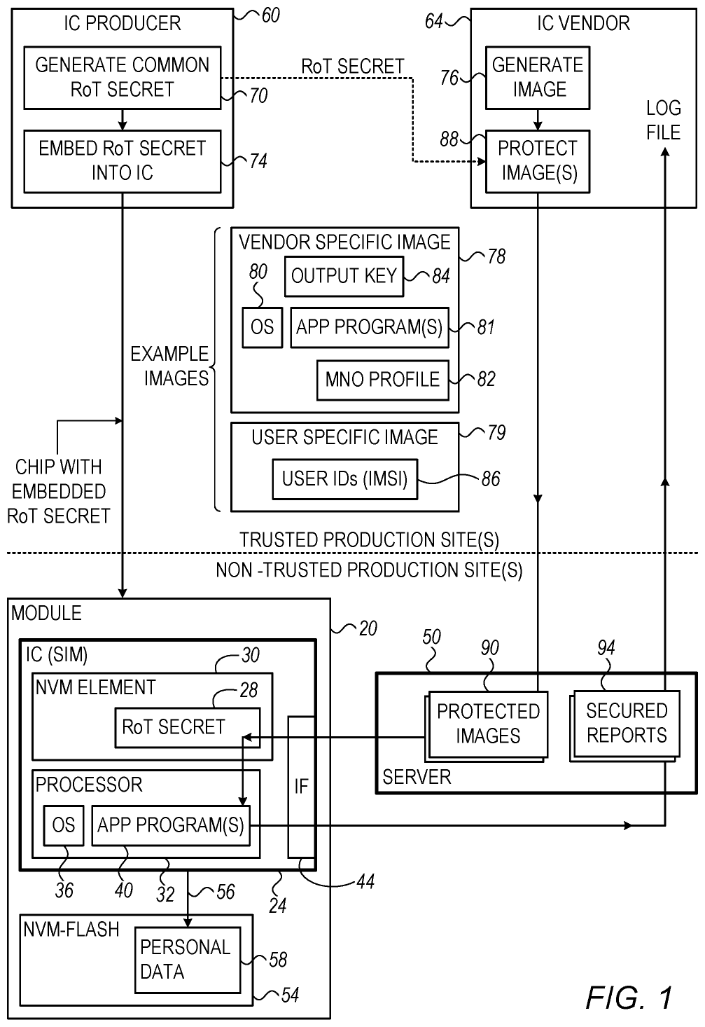

FIG. 1 is a block diagram that schematically illustrates a module 20 comprising an Integrated Circuit (IC) 24 produced with embedded Root of Trust (RoT) secret 28, and a process carried out for personalizing the IC, in accordance with an embodiment that is described herein.

Module 20 may comprise, for example, a credit card, SIM card, smart card or any other suitable type of personalized application that requires secure personalization. IC 24 is produced with a RoT secret 28, which is stored within the IC in any suitable type of a nonvolatile memory (NVM) element 30. NVM element 30 may comprise, for example, a One-Time Programmable (OTP) storage element, an array of nonvolatile memory cells, a fuse array and the like.

As will be described below, the IC uses the RoT secret for accepting a data image in a trusted manner, wherein the data image is used for internal personalization. A “data image” is also referred to herein as an “image” for brevity. Although different applications may require different respective types of images, a common RoT secret 28 used for multiple different types of images, which contributes to the scalability of the disclosed personalization scheme.

RoT secret 28 may comprise various types of information such as:
A public key for performing a secure boot that ensures authenticity of the software run by the processor. As will be described below, the software is received in a data image that is signed with an image signature based on the RoT secret.
One or more encryption keys for protecting the content of the data image.
A public key of a root Certificate Authority (CA) for authenticating connected peers (e.g., a peer server).
Personal ID/Keys such as an Elliptic Curve Cryptography (ECC) certificate and a private key, for attestation and authentication of the IC by an external entity.

Note that the personalization process requires a matching between the RoT secret embedded into the IC at production, and the RoT secret that is used for protecting the image to be loaded to the IC. An image protected based on a RoT secret different from the embedded RoT secret will be rejected by the IC.

In the context of the present disclosure the term “matching” with reference to RoT secret means that the RoT secret embedded in the IC and the entity that produces a protected image for the IC comprise one or more pairs of respective matching cryptographic keys for applying complementary respective cryptographic operations, such as encrypt and decrypt, signature generation and verification, and the like.

IC 24 comprises a processor 32, which is configured to run various programs such as an Operating System (OS) 36 and one or more application programs 40, including an application program 40 that is used for internal personalization.

IC 24 further comprises an interface (IF) 44 for communicating with an external server 50. For example, the processor receives image data from server 50 via IF 44, and sends personalization information to the server via IF 44. IF 44 may comprise any suitable link or bus such as, for example, Universal Serial Bus (USB), a Universal Asynchronous Receiver-Transmitter (UART) or an Ethernet link.

In the present example, IC 24 is coupled to a Nonvolatile Memory (NVM) 54 via a suitable link or bus 56. In alternative embodiments, NVM 54 is implemented within IC 24. NVM 54 may comprise any suitable type of a nonvolatile storage such as, for example, a Flash memory. In some embodiments, the processor stores in NVM 54 personal data 58, such as personal information generated by application program 40 and personal data provided within an image. Personal data 58 is securely stored in NVM 54. For example, in some embodiments, NVM 54 comprises a secure memory. In other embodiments, NVM 54 is riot a secure memory, and the IC securely stores personal data 58 in NVM 54 using any suitable cryptographic techniques.

FIG. 1 additionally depicts an IC producer 60 and an IC vendor 64, which will be described in detail further below. Example images 78 and 79 depicted in FIG. 1 will also be described below.

### Efficient IC Personalization Process

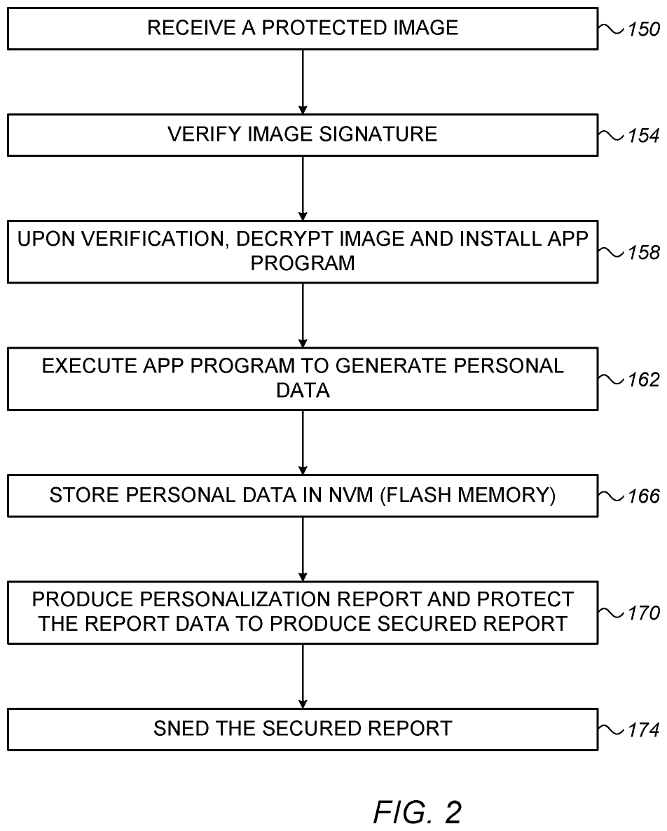

A process carried out for personalizing IC 24 is now described. The personalization process involves interaction among various elements such as IC producer 60, IC vendor 64, server 50 and IC 24. The process in FIG. 1 covers parts of the overall personalization process that involve elements external to IC 24. Parts of the personalization process that are carried out within IC 24 will be described in FIG. 2 below.

As noted above, the term “IC vendor” refers herein to any entity that generates, or otherwise provides, protected images for IC personalization. In some embodiments, the functionality of IC vendor 64 may be implemented within IC producer 60 or within any other suitable server.

A horizontal dotted line in FIG. 1 distinguishes between parts of the personalization process that are carried out in a trusted site (above the dotted line) and those carried out in a non-trusted site (below the dotted line).

The example process in FIG. 1 will be now described as a sequence of numbered steps. The process begins, at a RoT secret generation step 70, with IC producer 60 generating a RoT secret. In some embodiments, the IC producer may generate for multiple ICs (e.g., upon demand) same or different respective RoT secrets. As noted above, the same RoT secret can be used for multiple different applications and use-cases. IC producer 60 further provisions the RoT secret generated at step 70 into each produced IC, at a RoT secret provisioning step 74, to produce IC 24 in which RoT secret 28 is embedded.

At an image generation step 76, the IC vendor generates an image in accordance with the underlying application. In some embodiments, the IC vendor generates a vendor specific image 78 and a separate user specific image 79.

In the example of FIG. 1, vendor specific image 78 may comprise an OS 80 and one or more application programs 81, to be executed by processor 32, as OS 36 and application program(s) 40, respectively. In embodiments in which IC 24 comprises a SIM card, the vendor specific image may further comprise a Mobile Network Operator (MNO) profile 82, which specifies, for example, network parameters that are required by the MNO, file system and MNO applets. In some embodiments, the vendor specific image comprises an output key 84 that is used by the IC for producing secured reports, as will be described below. User specific image 79 comprises user personal data 86 such as a user ID. In embodiments in which IC 24 comprises a SIM card, the user ID may comprise an International Mobile Subscriber Identity (IMSI).

At an image protection step 88, IC vendor 64 produces a protected image 90 to be stored temporarily in server 50. In some embodiments the IC vendor produces the protected image by encrypting the image generated at step 76 and signing the encrypted image with a respective image signature. In alternative embodiments, the IC vendor first signs the image and then encrypts the signed image. The IC vendor may use for image protection any suitable encryption and signing schemes. An example encryption scheme comprises the Advanced Encryption Standard (AES) configured in a Counter Mode (AES-CTR) and an example signing scheme comprises the Elliptic Curve Digital Signature Algorithm (ECDSA). The encryption and signing operations use secret cryptographic keys that match respective cryptographic keys in the RoT secret embedded in IC 24. The IC vendor delivers the protected image to server 50, which stores it locally. The server typically stores a batch of multiple protected images destined to multiple ICs. At a later occasion, the server sends a selected protected image to IC 24 via IF 44 of the IC, as described above.

Note that accordance with the present personalization process, only an IC that has been produced with a RoT secret having keys that match keys used by the IC vendor for protecting the image is able to accept an image generated and protected by the IC vendor. The IC vendor may encrypt and sign the image using any suitable combination of symmetric and asymmetric credentials specified in the RoT secret.

The configurations of module 20 and IC 24 of FIG. 1 are given by way of example, which are chosen purely for the sake of conceptual clarity. In alternative embodiments, other suitable module and IC configurations can also be used. Some elements of module 20 and IC 24, such as processor 32, NVM 54 and IF 44, may be implemented in hardware, e.g., in one or more Application-Specific Integrated Circuits (ASICs) or Field-Programmable Gate Arrays (FPGAs). Additionally or alternatively, some elements of IC 24 can be implemented using software, or using a combination of hardware and software elements.

In the example system configuration shown in FIG. 1, IC 24 and NVM 54 are implemented as two separate Integrated Circuits (ICs). In alternative embodiments, however, the IC 24 and NVM 54 may be integrated on separate semiconductor dies in a single Multi-Chip Package (MCP) or System on Chip (SoC), and may be interconnected by an internal bus. Further alternatively, NVM 54 may reside on the same die on which IC 24 is disposed. In such embodiments, IC 24 itself serves as module 20.

In some embodiments, some of the functions of each of module 20 and IC 24 may be carried out by a general-purpose processor, e.g., processor 32, which is programmed in software to carry out the functions described herein. The software may be downloaded to the relevant processor in electronic form, over a network, for example, or it may, alternatively or additionally, be provided and/or stored on non-transitory tangible media, such as magnetic, optical, or electronic memory.

NVM element 30 may comprise any suitable type of nonvolatile storage for storing RoT secret 28. NVM 54 may be any suitable type of nonvolatile storage such as a Flash Memory.

Elements that are not necessary for understanding the principles of the present disclosure, such as various interfaces, addressing circuits, timing and sequencing circuits and debugging circuits, have been omitted from the figure for clarity.

FIG. 2 is a flow chart that schematically illustrates a method for internal personalization of IC 24 produced with embedded RoT secret 28, in accordance with an embodiment that is described herein. The method will be described as being executed by processor 32 of IC 24.

The method begins with processor 32 receiving a protected image, at an image protection step 150. The received image is protected based on RoT secret 28 that is embedded within the IC. In an embodiment, server 50 receives one or more protected images from IC vendor 64, and processor 32 receives the protected image(s) from server 50 via IF 44. The protected image is encrypted and signed as described above. The image contains an OS (36) and application program (40). In some embodiments, server 50 stores one or more protected images locally, and sends a selected image to the IC, at a later occasion.

At a signature verification step 154, processor 32 verifies an image signature of the protected image using a relevant key of RoT secret 28 that matches the key used by the IC vendor for signing the image. At a program installing step 158, when the image signature has been verified successfully, the processor decrypts the image using a relevant key in RoT secret 28 that matches the key used for encrypting the image by the IC vendor. In alternative embodiments, the processor first decrypts the image and then verifies signature. The processor then extracts application program 40 from the decrypted image and installs the extracted application program. In an embodiment, before extracting and installing the application program, the processor extracts OS 80 (and/or other software elements) from the decrypted image and installs it as OS 36 in the IC.

At a personal data generation step 162, the processor executes the application program for generating personal data. The application program may be designed for a specific IC vendor and thus, when executed, generates personal data in accordance with the requirements of the specific IC vendor. Alternatively, the application program comprises a generic program that generates personal data suitable for multiple different IC vendors. In some embodiments, the processor produces personal data by using both a vendor specific program and a generic application program.

By running the application program, the processor generates user specific and card specific data. For example, in embodiments in which the IC comprises a SIM card, the processor generates certain credentials and keys that the SIM card may use for accessing the mobile network. The personal data generated by the application program may include identification information such as MNO IDs received within a user specific image.

At a personal data storage step 166, the processor securely stores both the personal data received in the image and personal data generated by the application program, in NVM 54, depicted as personal data 58. This completes the personalization of IC 24 itself. In an embodiment, NVM 54 comprises a secure memory, and personal data 58 stored in NVM 54 is securely protected. In another embodiment, NVM 54 is not a secure memory, and the processor stores the personal data securely using any suitable cryptographic methods and keys.

At a report producing step 170, the processor produces a personalization report (e.g., for the IC vendor) that summarizes the IC personalization phase. In some embodiments, the processor includes in the personalization report information such as received IDs, IC IDs, and/or one or more keys that were generated by the application program. An IC ID is a vendor specific identifier of the IC itself. The processor may include in the personalization report any other suitable information that is relevant for the IC vendor.

In some embodiments, the processor produces a secured report 94 by protecting the report data using one or more cryptographic methods such as encryption, integrity verification and authentication. For example, the processor may apply to the report data a selected cryptographic method using a suitable cryptographic key. The cryptographic key may be provided to the IC within the protected image or within the embedded RoT secret. Alternatively, the processor applies to the report data a cryptographic method using a cryptographic key that has been agreed with the IC vendor using any other suitable key agreement scheme.

At a reporting step 174, the processor sends secured report 94 indirectly to IC vendor 64 via server 50. The processor sends the secured report to server 50 via IF 44, and server 50 typically stores locally multiple secured reports 94 of multiple respective ICs. At a suitable later occasion, the server sends to the IC vendor the multiple secured reports corresponding to a batch of multiple respective personalized ICs. Following step 174, the method terminates.

After concluding the personalization process, IC 24 (or module 24 comprising IC 24) is ready for operating in the field. Depending on the underlying application, the personal data now stored in NVM 54 and that is accessible to IC 24 may be used e.g., by a relevant service provider, for verifying the identification of the IC, validating that the IC resides in an authorized device and granting communication with the IC.

### Managing Personalization Log Files

In some embodiments, the IC vendor recovers the report data by applying to the secured report cryptographic methods in inverse operation and order to the cryptographic methods used for generating the secured report. In some embodiments, the IC vendor verifies (e.g., applies integrity and authentication verification) and decrypts each secured report using a decryption key and a signing verification key that match the encryption key and signing key agreed with the processor. The IC vendor creates a log file that summarizes personalization processes of multiple ICs. The IC vendor typically marks each image that has been used for personalization as used, to avoid IC duplication.

In some embodiments, the IC vendor scans the log file for identifying possible duplication events in which multiple ICs have been personalized with common personal data such as personalized data specified within the image, e.g., falsely assigning a common IMSI to multiple SIM cards. The IC vendor marks duplicate ICs as revoked or invalid ICs. The IC vendor sends a list of valid personalized ICs, e.g., to the owner of the personalized application that was loaded into the IC.

For example, when the ICs comprise SIM cards, the SIM vendor reports to the MNO the valid SIM cards that were personalized successfully, and the MNO configures the network database (e.g., in a Home Location Register—HLR) to accept these SIM cards as valid subscribers.

The embodiments described above are given way of example, and other suitable embodiments can also be used. For example, although in the embodiments described above the IC vendor generates data images and processes these images to be trusted, at least part of these operations may be carried out or involve entities other than the IC vendor.

In the embodiments described above, protected images destined to the IC and secured reports destined to the IC vendor are temporarily stored in an external server. This configuration not mandatory, and in alternative embodiments, the IC receives a protected image and/or sends a secured report directly from/to the TC vendor.

The embodiments described above are not limited to an IC whose entire functionality implements an application of a smart card. The disclosed embodiments are applicable also to ICs that may include various elements such as a modem, a Global Positioning System (GPS) receiver and other logic such as used, for example, in SIM-like applications.

It will be appreciated that the embodiments described above are cited by way of example, and that the following claims are riot limited to what has been particularly shown and described hereinabove. Rather, the scope includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An Integrated Circuit (IC), comprising:
a nonvolatile storage element that is pre-programmed with a Root of Trust (RoT) secret; and
a processor, configured to:
receive via an unsecured link a data image that is securely protected based on the RoT secret, the data image containing at least an application program for generating user personal data;
install the application program in response to verifying, using the RoT secret, that the received data image is trusted;
run the application program to generate the user personal data, securely within the IC; and
report the user personal data using a secured scheme.

2. The IC according to claim 1, wherein the IC with the pre-programmed RoT secret is applicable in multiple different devices selected from a list comprising: a smart card, a credit card, and a Subscriber Identity Module (SIM) card.

3. The IC according to claim 1, wherein the application program comprises a vendor specific program that generates for the IC personal data suitable for a specific vendor, or a generic program that generates for the IC personal data suitable for multiple different vendors.

4. The IC according to claim 1, wherein the processor is configured to receive another data image comprising user specific information provided by a vendor for which the IC is being personalized.

5. The IC according to claim 1, wherein the processor is coupled to a nonvolatile memory (NVM) device, and wherein the processor is configured to store in the NVM device one or more of (i) the user personal data that was generated using the application program and (ii) other personal data provided in the data image or in another data image.

6. The IC according to claim 1, wherein the processor is configured to protect the user personal data to be reported using one or more cryptographic methods and one or more respective cryptographic keys provided within the data image, within the RoT secret, or agreed, using a key agreement scheme, with a processor to which the user personal data is reported.

7. The IC according to claim 1, wherein the received data image comprises an image signature generated using a signature-generating key that matches a signature-verification key in the RoT secret, and wherein the processor is configured to verify that the received data image is trusted by verifying the image signature using the signature-verification key of the RoT secret.

8. The IC according to claim 1, wherein the processor is configured to report the user personal data for verifying that the IC has been uniquely personalized with the user personal data.

9. A method, comprising:
in an Integrated Circuit (IC) comprising a nonvolatile storage element that is pre-programmed with a Root of Trust (RoT) secret,
receiving via an unsecured link a data image that is securely protected based on the RoT secret, the data image contains at least an application program for generating user personal data;
installing the application program in response to verifying, using the RoT secret, that the received data image is trusted;
running the application program to generate the user personal data, securely within the IC; and
reporting the user personal data using a secured scheme.

10. The method according to claim 9, wherein the IC with the pre-programmed RoT secret is applicable in multiple different devices selected from a list comprising: a smart card, a credit card, and a Subscriber Identity Module (SIM) card.

11. The method according to claim 9, wherein the application program comprises a vendor specific program that generates for the IC personal data suitable for a specific vendor, or a generic program that generates for the IC personal data suitable for multiple different vendors.

12. The method according to claim wherein and comprising receiving another data image comprising user specific information provided by a vendor for which the IC is being personalized.

13. The method according to claim 9, wherein the IC comprises a processor coupled to a nonvolatile memory (NVM) device, and comprising storing by the processor, in the NVM device, one or more of (i) the user personal data that was generated using the application program and (ii) other personal data provided in the data image or in another data image.

14. The method according to claim 9, wherein reporting the user personal data comprises protecting the user personal data to be reported, using one or more cryptographic methods and one or more respective cryptographic keys provided within the data image, within the RoT secret, or agreed, using a key agreement scheme, with a processor to which the user personal data is reported.

15. The method according to claim 9, wherein the received data image comprises an image signature generated using a signature-generating key that matches a signature-verification key in the RoT secret, and wherein verifying that the received data image is trusted comprises verifying the image signature using the signature-verification key of the RoT secret.

16. The method according to claim 9, wherein reporting the user personal data comprises reporting the user personal data for verifying that the IC has been uniquely personalized with the user personal data.
